(19) United States
(12) Patent Application Publication
(10) Pub. No.: US 2015/0044558 A1
(43) Pub. Date: Feb. 12, 2015

(54) NEGATIVE ELECTRODE ACTIVE MATERIAL FOR SODIUM-ION BATTERY, SODIUM-ION BATTERY AND METHOD OF PRODUCING NEGATIVE ELECTRODE ACTIVE MATERIAL FOR SODIUM-ION BATTERY

(71) Applicant: Toyota Jidosha Kabushiki Kaisha, Toyota-shi (JP)

(72) Inventor: Hideki Nakayama, Susono-shi (JP)

(21) Appl. No.: 14/457,589

(22) Filed: Aug. 12, 2014

(30) Foreign Application Priority Data
Aug. 12, 2013 (JP) 2013-167422

(51) Int. Cl. H01M 4/60; H01M 4/62

(52) U.S. Cl. CPC H01M 4/60; H01M 4/625; H01M 2004/027
USPC 429/213; 252/506

(57) ABSTRACT

A negative electrode active material for a sodium-ion battery includes a negative electrode active material ingredient that is a compound having an aromatic ring structure and two or more COOX groups in which X is Li or Na, and which are bonded to ends of the aromatic ring structure; and a carbon material. The carbon material has an interlayer distance d002 equal to or smaller than 3.5 Å or a D/G ratio equal to or smaller than 0.80, the D/G ratio being obtained by Raman spectrometry.

### INCORPORATION BY REFERENCE

The disclosure of Japanese Patent Application No. 2013-167422 filed on Aug. 12, 2013 including the specification, drawings and abstract is incorporated herein by reference in its entirety.

### BACKGROUND OF THE INVENTION

1. Field of the Invention

The invention relates to a negative electrode active material for a sodium-ion battery, which has excellent charge and discharge efficiency.

2. Description of Related Art

Sodium-ion batteries are batteries in which sodium ions (Na ions) move between a positive electrode and a negative electrode. Sodium-ion batteries are advantageous in terms of being less costly than lithium (Li)-on batteries, since Na is more abundant than Li. Ordinarily, a sodium-ion battery includes a positive electrode active material layer that contains a positive electrode active material, a negative electrode active material layer that contains a negative electrode active material, and an electrolyte layer that is disposed between the positive electrode active material layer and the negative electrode active material layer.

The use of Na₂C₈H₄O₄ as a negative electrode active material that is utilized in sodium ion batteries has been described. For instance, Liang Zhao et al., “Disodium Terephthalate (Na₂C₅H₄O₄) as High Performance Anode Material for Low-Cost Room-Temperature Sodium-Ion Battery”, ADVANCED ENERGY MATERIALS, 2 (2012) 962-965 discloses a sodium-ion battery in which Na₂C₈H₄O₄ is used as a negative electrode active material. Although not a sodium-ion battery, M. Armand et al., “Conjugated dicarboxylate anodes for Li-ion batteries”, NATURE MATERIALS, VOL 8 (2009) 120-125 discloses a lithium-ion battery in which Li₂C₈H₄O₄ is used as a negative electrode active material. The same subject matter is described in Japanese Patent Application Publication No. 2012-221754 (JP 2012-221754 A).

There is a demand for a sodium-ion battery having excellent charge and discharge efficiency.

### SUMMARY OF THE INVENTION

The invention provides a negative electrode active material for a sodium-ion battery, which has excellent charge and discharge efficiency.

A first aspect of the invention relates to a negative electrode active material for a sodium-ion battery. The negative electrode active material includes a negative electrode active material ingredient that is a compound having an aromatic ring structure and two or more COOX groups in which X is Li or Na, and which are bonded to ends of the aromatic ring structure; and a carbon material. The carbon material has an interlayer distance d002 equal to or smaller than 3.5 Å or a D/G ratio equal to or smaller than 0.80, the D/G ratio being obtained by Raman spectrometry.

According to the above aspect of the invention, it is possible to provide the negative electrode active material for a sodium-ion battery, which has excellent charge and discharge efficiency, by including the above predetermined carbon material in the negative electrode active material.

In the above aspect of the invention, the negative electrode active material ingredient and the carbon material may be composited, since Na deintercalation capacity can be enhanced as a result.

A second aspect of the invention relates to a sodium-ion battery including a positive electrode active material layer that contains a positive electrode active material; a negative electrode active material layer that contains a negative electrode active material; and an electrolyte layer disposed between the positive electrode active material layer and the negative electrode active material layer. The negative electrode active material of the sodium-ion battery is the negative electrode active material according to the first aspect of the invention.

According to the second aspect of the invention, it is possible to provide the sodium-ion battery that has excellent charge and discharge efficiency, since the negative electrode active material of the sodium-ion battery is the negative electrode active material for a sodium-ion battery according to the first aspect of the invention.

A third aspect of the invention relates to a method of producing the negative electrode active material for a sodium-ion battery according to the first aspect of the invention. The method includes mixing the negative electrode active material ingredient and the carbon material.

According to the third aspect of the invention, it is possible to obtain the negative electrode active material with high Na deintercalation capacity by mixing the carbon material with the negative electrode active material ingredient.

In the above aspect of the invention, the negative electrode active material ingredient and the carbon material may be mixed by performing a compositing treatment so that the negative electrode active material ingredient and the carbon material are composited.

According to the above aspects of the invention, it is possible to provide the negative electrode active material for a sodium-ion battery, which has excellent charge and discharge efficiency.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic sectional diagram illustrating an example of a sodium-ion battery according to the invention;

FIG. 2 is a flowchart illustrating an example of a method for producing a negative electrode active material according to the invention; and

FIG. 3 is a diagram illustrating charge and discharge results of a first example and a first comparative example.

### DETAILED DESCRIPTION OF EMBODIMENTS

The invention relates to a negative electrode active material for a sodium-ion battery, to a production method thereof, and to a sodium-ion battery that uses the negative electrode active material for a sodium-ion battery. Hereinafter, the negative electrode active material for a sodium-ion battery, the method for producing a negative electrode active material for a sodium-ion battery and the sodium-ion battery according to the invention will be explained in detail.

A. Negative Electrode Active Material for a Sodium-Ion Battery

The negative electrode active material for a sodium-ion battery according to the invention will be explained first. The negative electrode active material for a sodium-ion battery according to the invention includes a negative electrode active material ingredient that is a compound having an aromatic ring structure and two or more COOX groups in which X is Li or Na, and which are bonded to the ends of the aromatic ring structure; and a carbon material, wherein the carbon material has an interlayer distance d002 equal to or smaller than 3.5 Å (angstrom) or a D/G ratio equal to or smaller than 0.80, the D/G ratio being obtained by Raman spectrometry.

According to the invention, it is possible to provide the negative electrode active material for a sodium-ion battery, which has excellent charge and discharge efficiency, by including the above predetermined carbon material in the negative electrode active material. The reason why the negative electrode active material for a sodium-ion battery has excellent charge and discharge efficiency as a result of including the above carbon material is not clear. However, it is considered as follows. The carbon material has high crystallinity, since the carbon material has an interlayer distance d002 equal to or smaller than 3.5 Å or a D/G ratio equal to or smaller than 0.80, the D/G ratio being obtained by Raman spectrometry. Accordingly, Na ions are intercalated into the carbon material less readily, and the irreversible capacity due to Na ion intercalation can be reduced. The charge and discharge efficiency can be enhanced as a result.

An organic material, which has a metal (for instance, X above) and an organic ligand (for instance, a COO group), such as the organic material that has the above two or more COOX groups, may be referred to as an organic metal-organic framework (MOF) material, since the organic material has a structure in which organic framework layers having the organic ligand, and metal layers having the metal are arrayed regularly in a layered manner, i.e. a so-called MOF structure. In a case where the site having the organic ligand includes the structure having the conjugated π-electron cloud, it is deemed that the organic framework layer, which includes the structure having the conjugated π-electron cloud, functions as a redox site, while the metal layer functions as an Na ion storage site, so that charge and discharge, i.e. storage and release of energy, can be performed. In the invention, the negative electrode active material ingredient that is the above compound has the above aromatic ring structure as the structure having the conjugated π-electron cloud. Thus, the negative electrode active material ingredient has the conjugated π-electron cloud that is spread widely, and accordingly, electrons can be transferred smoothly. Excellent charge and discharge efficiency can accordingly be achieved by using the above negative electrode active material ingredient together with the above carbon material.

The negative electrode active material according to the invention includes the negative electrode active material ingredient and the carbon material. Hereinafter, the components of the negative electrode active material according to the invention will be explained in detail.

1. Carbon Material

The carbon material according to the invention has an interlayer distance d002 equal to or smaller than 3.5 Å, or a D/G ratio equal to or smaller than 0.80, the D/G ratio being obtained by Raman spectrometry. The carbon material functions as a conductive material.

The interlayer distance d002 of the carbon material is not particularly limited so long as it is equal to or smaller than 3.5 Å, but is more preferably equal to or smaller than 3.45 Å, and particularly preferably equal to or smaller than 3.4 Å, since a highly crystalline carbon material can be provided and charge and discharge efficiency can be enhanced. The interlayer distance d002 is generally equal to or greater than 3.3 Å. The interlayer distance d002 signifies the interplanar spacing between (002) planes in the carbon material, and specifically corresponds to the distance between graphene layers. The interlayer distance d002 can be determined for instance on the basis of peaks obtained by X-ray diffraction (XRD) using CuKα rays.

The D/G ratio of the carbon material as obtained on the basis of Raman spectrometry is not particularly limited so long as it is equal to or smaller than 0.80, but is more preferably equal to or smaller than 0.6, more preferably, in particular, equal to or smaller than 0.4, and even yet more preferably equal to or smaller than 0.2, since a highly crystalline carbon material can be provided. The D/G ratio signifies herein the intensity of a D-band peak due to a defect structure, in the vicinity of 1350 cm⁻¹, with respect to the intensity of a G-band peak due to a graphite structure, in the vicinity of 1590 cm⁻¹, the D/G ratio being determined by Raman spectrometry (wavelength 532 nm).

Examples of the carbon material include, specifically, carbon black such as acetylene black, Ketjen black, furnace black and thermal black; carbon fibers such as vapor grown carbon fibers (VGCFs); graphite; hard carbon; coke and the like. Preferred among the foregoing in the invention are carbon fibers such as VGCFs, since the above interlayer distance and D/G ratio can be easily achieved in this case.

The proportion of the carbon material with respect to the total amount of the negative electrode active material ingredient and the carbon material ranges preferably, for instance, from 1 wt % to 30 wt %, more preferably form 5 wt % to 20 wt %. That is because in a case where, for instance, the negative electrode active material ingredient and the carbon material are composited, the Na deintercalation capacity may not be sufficiently enhanced if the proportion of the composited carbon material is excessively small, whereas if the proportion of the composited carbon material is excessively large, the amount of active material decreases relatively, and capacity may drop.

2. Negative Electrode Active Material Ingredient

The negative electrode active material ingredient according to the invention is a compound having an aromatic ring structure and COOX groups.

The aromatic ring structure has at least one aromatic ring.

The type of the aromatic ring in the aromatic ring structure may be that of an aromatic hydrocarbon in which the elements that constitute the ring structure of the aromatic ring are carbon alone, or an aromatic heterocycle having heteroatoms.

In the aromatic ring structure, the ring structure of the aromatic ring needs to be a ring structure that exhibits aromaticity. Herein, the ring structure may be a five-membered ring, a six-membered ring exemplified by Formula (1) below, a seven-membered ring or an eight-membered ring, but is preferably a six-membered ring, since excellent charge and discharge efficiency can be achieved.

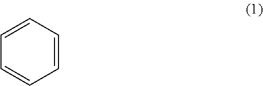

The number of aromatic rings in the aromatic ring structure may be one, or may be two or more, but ranges preferably from 1 to 3, and is preferably 1, since energy density can be increased. When the aromatic ring structure includes two or more aromatic rings, the aromatic ring structure may have a polycyclic structure in which aromatic rings are linked to each other via a single bond, as exemplified by Formula (2) below, or may have a condensed polycyclic structure in which aromatic rings are bonded to each other through condensation, as exemplified by Formula (3) below.

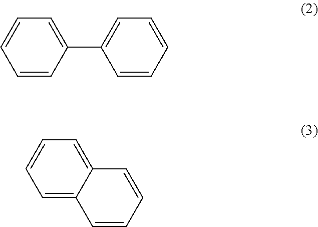 [SMILES: c1ccc(-c2ccccc2)cc1 ; c1ccc2ccccc2c1]

Specific examples of the aromatic ring structure include the structures represented by Formulas (1) to (3). The structure represented by Formula (1) is preferably employed among the foregoing, since excellent charge and discharge efficiency can be achieved.

Two or more COOX groups (where X is Li or Na) according to the invention are bonded to the above aromatic ring structure.

Either one of Li and Na may be used as X in the COOX group, but Na is preferred herein, since excellent charge and discharge efficiency can be achieved.

The number of COOX groups bonded to the aromatic ring structure is not particularly limited, so long as the number is equal to or greater than 2 and a stable MOF structure can be formed. For instance, the number of COOX groups ranges preferably from 2 to 4, and is preferably 2 within that range, since excellent charge and discharge efficiency can be achieved.

The bonding sites, at which the COOX groups are bonded to the aromatic ring structure, are the ends of the aromatic ring structure. The feature that the COOX groups are bonded to the ends of the aromatic ring structure signifies that the COOX groups are bonded to carbon atoms that form the ring structure of the aromatic ring in the aromatic ring structure. When the number of COOX groups is two, the COOX groups are preferably bonded at diagonal positions in the aromatic ring structure, and are particularly preferably positioned in such a manner that spacing between the bonding sites, at which the COOX groups are bonded, is greatest. Herein, diagonal positions in the aromatic ring structure signify such positions that a line that joins the bonding sites extends only within the aromatic rings and on the single bond that joins aromatic rings to each other, in the aromatic ring structure. Specifically, in a case where the aromatic ring structure is a benzene ring and there are two COOX groups, the COOX groups are preferably bonded to the aromatic ring structure in such a manner that the COOX groups are at para positions.

Specific examples of the negative electrode active material ingredient include those represented by Formulas (4) to (6) below. The negative electrode active material ingredient represented by Formula (4) is preferably used among the foregoing, since excellent charge and discharge efficiency can be achieved.

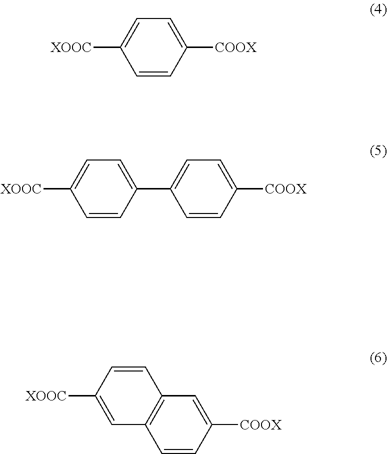

The method for producing the negative electrode active material ingredient is not particularly limited so long as the method allows obtaining the above-described active material, but may be for instance a method that includes neutralizing, with lithium hydroxide or sodium hydroxide, a compound having two or more carboxyl groups bonded to an aromatic ring structure. Specifically, the method may include stirring a compound having two or more carboxyl groups bonded to an aromatic ring structure, and lithium hydroxide or sodium hydroxide, in ethanol, followed by drying, for instance vacuum-drying.

3. Negative Electrode Active Material for a Sodium-Ion Battery

The negative electrode active material according to the invention includes the negative electrode active material ingredient and the carbon material.

The negative electrode active material ingredient and the carbon material may be composited, or may be present in a state of being mixed with each other, or may be in both states. Among the foregoing, the negative electrode active material ingredient and the carbon material in the invention are preferably composited, since Na deintercalation capacity can be enhanced. The feature “the negative electrode active material ingredient and the carbon material are composited” signifies a state ordinarily obtained by subjecting the negative electrode active material ingredient and the carbon material to a mechanochemical treatment. Examples of that state include a state in which both materials are dispersed so as to be in close contact with each other, at the nanometer scale, and a state in which one of the materials is dispersed so as to be in close contact with the surface of the other material, at the nanometer scale. Chemical bonds may exist between the materials. Whether the materials are composited or not can be verified, for instance, by scanning electron microscope (SEM) observation, transmission electron microscope (TEM) observation, TEM-electron energy-loss spectroscopy (EELS) or X-ray absorption fine structure (XAFS).

Preferably, the positive electrode active material is for instance particulate. The average particle size (D₅₀) ranges for instance from 1 nm to 100 μm, and preferably from 10 nm to 30 μm.

B. Sodium-Ion Battery

The sodium-ion battery according to the invention will be explained next. The sodium-ion battery according to the invention includes a positive electrode active material layer that contains a positive electrode active material, a negative electrode active material layer that contains a negative electrode active material, and an electrolyte layer disposed between the positive electrode active material layer and the negative electrode active material layer, wherein the negative electrode active material is the above-described negative electrode active material for a sodium-ion battery.

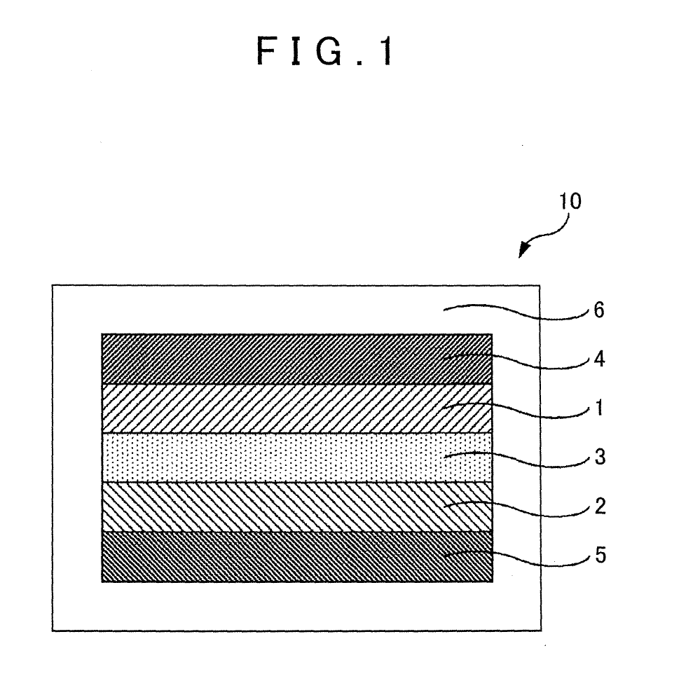

The sodium-ion battery according to the invention will be explained next with reference to accompanying drawings. FIG. 1 is a schematic sectional diagram illustrating an example of a sodium-ion battery according to the invention. A sodium-ion battery 10 illustrated in FIG. 1 includes a positive electrode active material layer 1, a negative electrode active material layer 2, an electrolyte layer 3 that is disposed between the positive electrode active material layer 1 and the negative electrode active material layer 2, a positive electrode collector 4 that collects current of the positive electrode active material layer 1, a negative electrode collector 5 that collects current of the negative electrode active material layer 2, and a battery case 6 that accommodates the foregoing members. A major feature of the sodium-ion battery according to the invention is that the negative electrode active material layer 2 contains the negative electrode active material described in the section “A. Negative electrode active material for a sodium-ion battery” above.

According to the invention, it is possible to provide the sodium-ion battery that has excellent charge and discharge efficiency since the negative electrode active material of the sodium-ion battery is the above-described negative electrode active material for a sodium-ion battery.

According to the invention, the sodium-ion battery includes at least the negative electrode active material layer, the positive electrode active material layer and the electrolyte layer. The configuration of the sodium-ion battery according to the invention will be explained next.

1. Negative Electrode Active Material Layer

The negative electrode active material layer according to the invention will be explained first. The negative electrode active material layer according to the invention contains the above-described negative electrode active material. The negative electrode active material layer may contain, in addition to the negative electrode active material, at least one from among a conductive material, a binder and a solid electrolyte material.

The particulars of the negative electrode active material are identical to those described in the section “A. Negative electrode active material for a sodium-ion battery” above, and will not be explained again herein.

The negative electrode active material layer according to the invention preferably contains a conductive material. The conductive material may be a conductive material that is composited with the negative electrode active material, or may be a material that is present, in the negative electrode active material layer, in a state of being not composited but mixed with the negative electrode active material, or may be both. The conductive material that is composited is not particularly limited, so long as it has a desired electron conductivity. Examples of the conductive material include carbon materials and metal materials, and carbon materials are preferable among the foregoing. Examples of the carbon materials include, specifically, carbon black such as acetylene black, Ketjen black, furnace black and thermal black; carbon fibers such as VGCFs; graphite; hard carbon; coke and the like. Examples of metal materials include Fe, Cu, Ni, Al and the like. Among the foregoing, the conductive material is preferably a carbon material. Particularly preferably, the carbon material has high crystallinity. That is because Na ions are intercalated into the carbon material less readily, and the irreversible capacity due to Na ion intercalation can be reduced, if the crystallinity of the carbon material is high. The charge and discharge efficiency can be enhanced as a result. The crystallinity of the carbon material can be specified, for instance, by the interlayer distance d002 and the D/G ratio. The carbon materials described in “A. Negative electrode active material for a sodium-ion battery” can be specifically used as such highly crystalline carbon materials.

The binder is not particularly limited, so long as it is chemically and electrically stable. Examples of the binder include fluorine-based binders such as polyvinylidene fluoride (PVDF) and polytetrafluoroethylene (PTFE), rubber-based binders such as styrene-butadiene rubber, olefin-based binders such as polypropylene (PP) and polyethylene (PE), and cellulose-based binders such as carboxymethyl cellulose (CMC). The solid electrolyte material is not particularly limited so long as it has a desired ion conductivity. Examples of the solid electrolyte material include oxide solid electrolyte materials and sulfide solid electrolyte materials. The solid electrolyte material will be explained in detail in the section “3. Electrolyte layer”.

The content of the negative electrode active material in the negative electrode active material layer is preferably larger, in terms of capacity; for instance, the content ranges preferably from 60 wt % to 99 wt %, and particularly preferably from 70 wt % to 95 wt %. The content of the conductive material is preferably smaller, so long as a desired electron conductivity can be secured, and the content of the conductive material ranges for instance from 5 wt % to 80 wt %, and preferably from 10 wt % to 40 wt %. That is because if the content of the conductive material is excessively small, sufficient electron conductivity may not be achieved, whereas if the content of the conductive material is excessively large, the amount of active material decreases relatively, and capacity may drop. The content of the conductive material does not include the carbon material of the negative electrode active material. The content of the binder is preferably smaller, so long as the negative electrode active material and so forth can be fixed stably, and the content of the binder ranges preferably, for instance, from 1 wt % to 40 wt % in the negative electrode active material layer. That is because if the content of binder is excessively small, sufficient binding properties may not be achieved, whereas if the content of the binder is excessively large, the amount of active material decreases relatively, and capacity may drop. The content of the solid electrolyte material is preferably smaller, so long as the desired ion conductivity can be secured, and the content of the solid electrolyte material ranges preferably, for instance, from 1 wt % to 40 wt % in the negative electrode active material layer. That is because if the content of the solid electrolyte material is excessively small, sufficient ion conductivity may not be achieved, whereas if the content of the solid electrolyte material is excessively large, the amount of active material decreases relatively, and capacity may drop.

The thickness of the negative electrode active material layer varies significantly depending on the configuration of the battery, but ranges preferably, for instance, from 0.1 μm to 1000 μm.

2. Positive Electrode Active Material Layer

The positive electrode active material layer according to the invention will be explained next. The positive electrode active material layer according to the invention contains at least the positive electrode active material. The positive electrode active material layer may contain, in addition to the positive electrode active material, at least one from among a conductive material, a binder and a solid electrolyte material.

The positive electrode active material is not particularly limited, so long as the positive electrode active material contains sodium and electrically allows sodium intercalation and deintercalation reactions to occur. Examples of the positive electrode active material include layered active materials, spinel-type active materials and olivine-type active materials. Specific examples of the positive electrode active material include NaFeO₂, NaNiO₂, NaCoO₂, NaMnO₂, NaVO₂, Na(Ni_{X}Mn₁₋ₓ)O₂ (0<X<1), Na(Fe_{X}Mn_{1-X})O₂ (0<X<1), NaVPO₄F, Na₂FePO₄F, Na₃V₂(PO₄)₃ and the like.

Preferably, the positive electrode active material is particulate. The average particle size (D₅₀) of the positive electrode active material ranges, for instance, from 1 nm to 100 μm, and preferably from 10 nm to 30 μm. The content of the positive electrode active material in the positive electrode active material layer is preferably larger, in terms of capacity; for instance, the content ranges preferably from 60 wt % to 99 wt %, and particularly preferably from 70 wt % to 95 wt %. The types and contents of the conductive material, binder and solid electrolyte material that are used in the positive electrode active material layer are identical to those of the negative electrode active material layer described above, and hence will not be explained again herein. The thickness of the positive electrode active material layer varies significantly depending on the configuration of the battery, but ranges preferably, for instance, from 0.1 μm to 1000 μm.

3. Electrolyte Layer

The electrolyte layer according to the invention will be explained next. The electrolyte layer according to the invention is disposed between the positive electrode active material layer and the negative electrode active material layer. Conduction of ions between the positive electrode active material and the negative electrode active material takes place via the electrolyte in the electrolyte layer. The form of the electrolyte layer is not particularly limited, and examples thereof include a liquid electrolyte layer, a gel electrolyte layer, a solid electrolyte layer and the like.

The liquid electrolyte layer is a layer ordinarily obtained using a nonaqueous electrolyte solution. The nonaqueous electrolyte solution contains ordinarily a sodium salt and a nonaqueous solvent. Examples of the sodium salt include inorganic sodium salts such as NaPF₆, NaBF₄, NaClO₄ and NaAsF₆, and organic sodium salts such as NaCF₃SO₃, NaN(CF₃SO₂)₂, NaN(C₂F₅SO₂)₂, NaN(FSO₂)₂, NaC(CF₃SO₂)₃ and the like. The nonaqueous solvent is not particularly limited so long as it dissolves the sodium salt. Examples of high-dielectric-constant solvents include cyclic esters (cyclic carbonates) such as ethylene carbonate (EC), propylene carbonate (PC) and butylene carbonate (BC); and γ-butyrolactone, sulfolane, N-methylpyrrolidone (NMP), 1,3-dimethyl-2-imidazolidinone (DMI) and the like. Low-viscosity solvents include chain esters (chain carbonates) such as dimethyl carbonate (DMC), diethyl carbonate (DEC) and ethyl methyl carbonate (EMC), acetates such as methyl acetate and ethyl acetate, and ethers such as 2-methyl tetrahydrofuran. A mixed solvent resulting from mixing a high-dielectric-constant solvent and a low-viscosity solvent may be used herein. The concentration of the sodium salt in the nonaqueous electrolyte solution ranges for instance from 0.3 mol/L to 5 mol/L, preferably from 0.8 mol/L to 1.5 mol/L. That is because if the concentration of sodium salt is excessively low, high-rate capacity may decrease, whereas if the concentration of the sodium salt is excessively high, viscosity increases, and low-temperature capacity may decrease. For instance, in the invention a low-volatile liquid such as an ionic liquid may be used as the nonaqueous electrolyte solution.

The gel electrolyte layer can be obtained, for instance, through gelling of a nonaqueous electrolyte solution by adding a polymer thereto. Specifically, gelling can be accomplished by adding, to a nonaqueous electrolyte solution, a polymer such as polyethylene oxide (PEO), polyacrylonitrile (PAN) or polymethyl methacrylate (PMMA).

The solid electrolyte layer is a layer obtained by using the solid electrolyte material. The solid electrolyte material is not particularly limited so long as it has a desired Na ion conductivity, but examples thereof include oxide solid electrolyte materials and sulfide solid electrolyte materials. Examples of oxide solid electrolyte materials include Na₃Zr₂Si₂PO₁₂, β alumina solid electrolytes (for example Na₂O-11Al₂O₃) and the like. Examples of sulfide solid electrolyte materials include Na₂S—P₂S₅ and the like.

The solid electrolyte material in the invention may be amorphous or crystalline. Preferably, the solid electrolyte material is particulate. The average particle size (D₅₀) of the solid electrolyte material ranges, for instance, from 1 nm to 100 μm, and preferably from 10 nm to 30 μm.

The thickness of the electrolyte layer varies significantly depending on the type of the electrolyte and on the configuration of the battery, but ranges for instance from 0.1 μm to 1000 μm, and preferably from 0.1 μm to 300 μm.

4. Other Features

The sodium-ion battery according to the invention includes at least the above-described negative electrode active material layer, positive electrode active material layer and electrolyte layer. Ordinarily, the sodium-ion battery further includes a positive electrode collector that collects current of the positive electrode active material layer and a negative electrode collector that collects current of the negative electrode active material layer. Examples of the material of the positive electrode collector include stainless steel (SUS), aluminum, nickel, iron, titanium, carbon and the like. Examples of the material of the negative electrode collector include SUS, copper, nickel, carbon and the like. Each of the positive electrode collector and the negative electrode collector may be, for instance, in the form of a foil or a mesh, or may be porous.

The sodium-ion battery according to the invention may include a separator between the positive electrode active material layer and the negative electrode active material layer, since a battery that has yet higher safety can be obtained. Specific examples of the material of the separator include porous membranes of polyethylene (PE), polypropylene (PP), cellulose, polyvinylidene fluoride (PVDF) or the like, and nonwoven fabrics such as resin nonwoven fabrics and glass-fiber nonwoven fabrics. The separator may have a single-layer structure (for instance, of PE or PP) or a multilayer structure (for instance, PP/PE/PP). The battery case of an ordinary battery can be used herein as the battery case that is utilized in the invention. Examples of battery cases include battery cases made of SUS.

5. Sodium-Ion Battery

The sodium-ion battery according to the invention is not particularly limited so long as the battery includes the above-described positive electrode active material layer, negative electrode active material layer and electrolyte layer. The sodium-ion battery according to the invention may be a battery in which the electrolyte layer is a solid electrolyte layer, a battery in which the electrolyte layer is a liquid electrolyte layer, or a battery in which the electrolyte layer is a gel electrolyte layer. Further, the sodium-ion battery according to the invention may be a primary battery or a secondary battery, but is preferably a secondary battery among the foregoing, since a secondary battery can be charged and discharged repeatedly, and is thus useful for instance as an in-vehicle battery. The shape of the sodium-ion battery according to the invention may be, for instance, a coin shape, a laminate shape, a cylindrical shape or a square or rectangular shape. The method of producing the sodium-ion battery is not particularly limited, and may be the same as a production method for an ordinary sodium-ion battery.

C. Method of Producing a Negative Electrode Active Material for a Sodium-Ion Battery

A method of producing a negative electrode active material for a sodium-ion battery according to the invention will be explained next. The method of producing a negative electrode active material for a sodium-ion battery according to the invention is a method of producing the above-described negative electrode active material for a sodium-ion battery, and the method includes mixing the negative electrode active material ingredient and the carbon material.

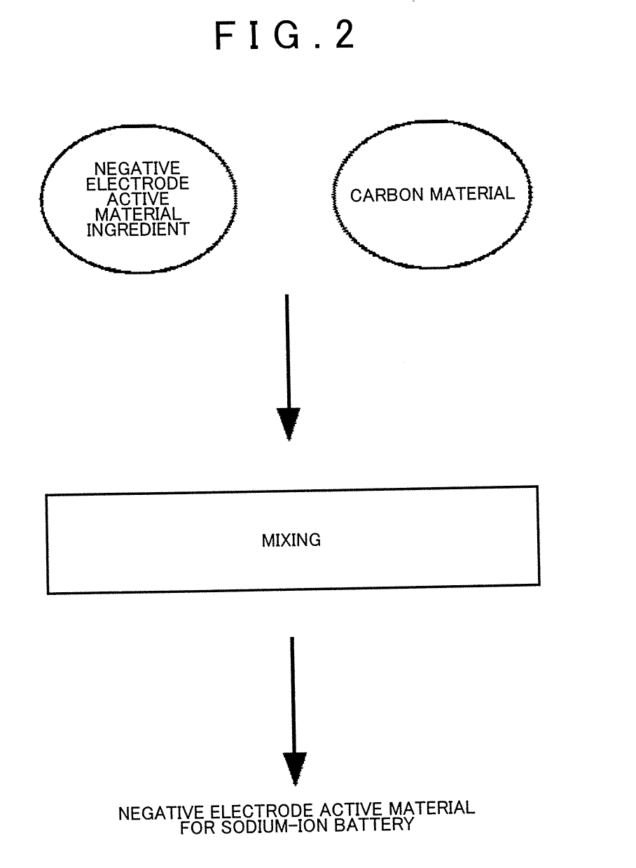

FIG. 2 is a flowchart illustrating an example of the method of producing the negative electrode active material for a sodium-ion battery according to the invention. Firstly, the negative electrode active material ingredient and the carbon material are prepared. Next, a mechanochemical treatment as a compositing treatment is performed on the negative electrode active material ingredient and the carbon material to mix the negative electrode active material ingredient and the carbon material. Thus, the negative electrode active material, in which the negative electrode active material ingredient and the carbon material are composited, is obtained.

According to the invention, through mixing of the negative electrode active material ingredient and the predetermined carbon material in the mixing process, it is possible to obtain the negative electrode active material having excellent charge and discharge efficiency.

The method of producing a negative electrode active material for a sodium-ion battery according to the invention includes mixing the negative electrode active material ingredient and the carbon material. The processes of the method of producing a negative electrode active material for a sodium-ion battery according to the invention will be explained next in detail.

1. Mixing Process

The mixing process according to the invention is a process of mixing the negative electrode active material ingredient and the carbon material.

The mixing method in the process is not particularly limited, so long as it is a method that allows the negative electrode active material ingredient and the carbon material to be homogeneously mixed, and a conventional method may be employed; for instance a method in which a mortar, a ball mill or the like is used. In the process, a method is preferred that includes mixing the negative electrode active material ingredient and the carbon material by performing a compositing treatment so that the negative electrode active material ingredient and the carbon material are composited, since it is possible to obtain the negative electrode active material in which the negative electrode active material ingredient and the carbon material are composited. The compositing treatment is not particularly limited, so long as the negative electrode active material ingredient and the carbon material are composited by the compositing treatment. However, the compositing treatment is preferably a mechanochemical treatment. Examples of mechanochemical treatments include treatments that allow imparting mechanical energy, specifically, for instance, treatments using ball mills. A commercially available compositing device (for instance, Nobilta by Hosokawa Micron Corporation) or the like can be used herein.

The particulars of the negative electrode active material ingredient and carbon material that are used in the process are the same as those set forth in the section “A. Negative electrode active material for a sodium-ion battery”, and will not be explained again herein.

2. Method of Producing a Negative Electrode Active Material for a Sodium-Ion Battery

The method of producing a negative electrode active material for a sodium-ion battery according to the invention includes mixing the negative electrode active material ingredient and the carbon material. The particulars of the negative electrode active material for a sodium-ion battery obtained according to the invention are the same as those set forth in the section “A. Negative electrode active material for a sodium-ion battery”, and will not be explained again herein.

The invention is not limited to the above embodiments. The foregoing embodiments are merely illustrative, and thus the technical scope of the invention encompasses any configuration that involves substantially the same features as those of the technical idea according to the invention and set forth in the claims, and that elicits substantially the same effect as that of the technical idea.

The invention will be explained more specifically based on the examples below.

### First Comparative Example

Terephthalic acid, NaOH and EtOH were placed into an eggplant flask, and stirring was performed under reflux. Thereafter, the whole was cooled to room temperature, was washed with EtOH, and was vacuum-dried at 140° C., to yield an organic material of a Na salt (negative electrode active material ingredient).

### First Example

The organic material of the Na salt (negative electrode active material ingredient) synthesized in the first comparative example and a highly crystalline carbon material (VGCFs) were mixed at a weight ratio of 90%/10%. The resulting mixture was subjected to a ball-mill treatment for 24 hours at revolutions of 180 revolution per minute (rpm), using ZrO₂ balls, to synthesize thereby a material (negative electrode active material) in which the organic material and the carbon material are composited. The VGCFs used herein had an interlayer distance d002=3.37 Å and a Raman D/G ratio=0.07.

(Production of a battery for evaluation) A battery for evaluation using the obtained active material was produced. Firstly, the obtained active material, a conductive material (acetylene black) and a binder (polyvinylidene fluoride (PVDF)) were mixed, at a weight ratio of negative electrode active material:conductive material:binder=85:10:5, and the mixture was kneaded, to yield a paste. Next, the obtained paste was applied onto a copper foil, using a doctor blade, and the whole was dried and pressed, to yield a 20 μm-thick test electrode. In the first comparative example, the negative electrode active material ingredient was mixed as the negative electrode active material.

Thereafter, a CR2032-type coin cell was used, the above test electrode was used as a working electrode, metallic Na was used as a counter electrode, and a porous separator of polyethylene/polypropylene/polyethylene (PE/PP/PE) (thickness 25 μm) was used as a separator. A solution, which was obtained by dissolving NaPF₆, at a concentration of 1 mol/L, in a mixed solvent of equal volumes of ethylene carbonate (EC) and diethyl carbonate (DEC), was used as an electrolyte solution. A battery for evaluation was obtained as a result.

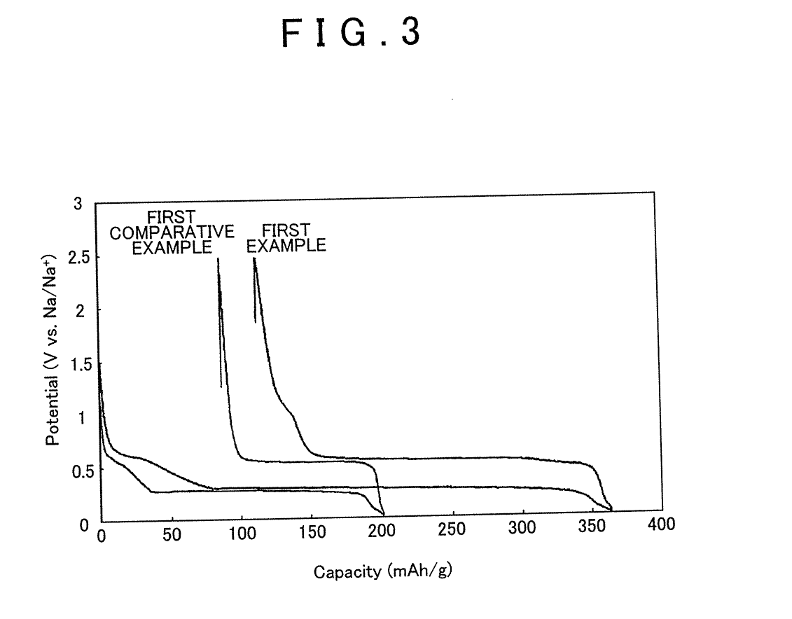

(Charge and discharge test) A charge and discharge test was performed on the batteries for evaluation obtained in the first comparative example and the first example. Specifically, each battery was charged and discharged, at an environmental temperature of 25° C. and a C/50 current value (upper and lower limit voltages 2.5 V to 10 mV). The results are illustrated in FIG. 3. Herein, FIG. 3 is a diagram illustrating the charge and discharge results on the first comparative example and the first example. Table 1 shows the results obtained on the basis of FIG. 3, that is, Na intercalation capacity, Na deintercalation capacity, charge and discharge efficiency and charge and discharge potential difference, of the batteries in which the materials were used.

TABLE 1

| | | | | | | Charge |
|---|---|---|---|---|---|---|
| | | | | Na | Na | and |
| | | | | intercalation | deintercalation | discharge |
| | | End | Carbon | capacity | capacity | efficiency |
| | Structure | structure | compositing | (×Na) | (×Na) | (%) |
| First comparative example | 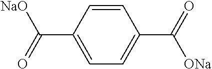 | COONa | — | 1.58 | 0.89 | 56.5 |
| First example | 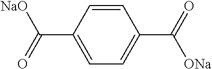 | COONa | VGCF | 2.85 | 1.96 | 68.8 |

(X-ray diffractometry) The active material powder of the first comparative example was subjected to powder X-ray diffractometry. The measurement was performed using an X-ray diffractometer (RINT 2200, manufactured by Rigaku Corporation), using CuKα rays (wavelength 1.54051 Å) as radiant rays. In the measurement that was performed, a graphite single-crystal monochromator was used to render X-rays monochromatic, the applied voltage was set to 40 kV, the current was set to 30 mA, and the angle range was set to 2θ=10° to 90° at a scanning rate of 4°/minute. The results revealed that the first comparative example had a crystalline structure attributable to the spatial group Pbc2₁.

As FIG. 3 and Table 1 show, the reversible capacity (the first comparative example: 113 mAh/g, 0.89Na⁺→the first example: 250 mAh/g, 1.96 Na⁺) and the charge and discharge efficiency (the first comparative example: 56.5%→the first example: 68.8%) increased significantly as a result of compositing the organic material (theoretical capacity=255 mAh/g at the time of the 2Na⁺ reaction) of the first comparative example with the highly crystalline carbon material. Although using a carbon material having a large interlayer distance and a large D/G ratio is not problematic in Li ion batteries, it was found that in the case of Na ion batteries, using a carbon material with poor crystallinity, which has a large interlayer distance and large D/G ratio, resulted in impaired reversibility (charge and discharge efficiency) of the battery, due to irreversible Na intercalation and deintercalation reactions.

What is claimed is:

1. A negative electrode active material for a sodium-ion battery, comprising:
a negative electrode active material ingredient that is a compound having an aromatic ring structure and two or more COOX groups in which X is Li or Na, and which are bonded to ends of the aromatic ring structure; and
a carbon material, wherein
the carbon material has an interlayer distance d002 equal to or smaller than 3.5 Å or a D/G ratio equal to or smaller than 0.80, the D/G ratio being obtained by Raman spectrometry.

2. The negative electrode active material according to claim 1, wherein
the interlayer distance d002 is equal to or smaller than 3.45 Å.

3. The negative electrode active material according to claim 2, wherein
the interlayer distance d002 is equal to or smaller than 3.4 Å.

4. The negative electrode active material according to claim 1, wherein
the interlayer distance d002 is equal to or greater than 3.3 Å.

5. The negative electrode active material according to claim 1, wherein
the D/G ratio is equal to or smaller than 0.6.

6. The negative electrode active material according to claim 5, wherein
the D/G ratio is equal to or smaller than 0.4.

7. The negative electrode active material according to claim 6, wherein
the D/G ratio is equal to or smaller than 0.2.

8. The negative electrode active material according to claim 1, wherein the negative electrode active material ingredient and the carbon material are composited.

9. A sodium-ion battery comprising:
a positive electrode active material layer that contains a positive electrode active material;
a negative electrode active material layer that contains a negative electrode active material; and
an electrolyte layer disposed between the positive electrode active material layer and the negative electrode active material layer, wherein
the negative electrode active material of the sodium-ion battery is the negative electrode active material according to claim 1.

10. A method of producing the negative electrode active material for a sodium-ion battery according to claim 1, comprising:
mixing the negative electrode active material ingredient and the carbon material.

11. The method according to claim 10, wherein the negative electrode active material ingredient and the carbon material are mixed by performing a compositing treatment so that the negative electrode active material ingredient and the carbon material are composited.
